(19) United States
(12) Patent Application Publication
(10) Pub. No.: US 2012/0227519 A1
(43) Pub. Date: Sep. 13, 2012

(54) Actuating Mechanism for Electric Vehicle Charging System

(76) Inventor: Satyajit Patwardhan, Fremont, CA (US)

(21) Appl. No.: 13/413,647

(22) Filed: Mar. 6, 2012

Related U.S. Application Data
(60) Provisional application No. 61/449,728, filed on Mar. 7, 2011.

(51) Int. Cl. F16H 21/22

(52) U.S. Cl. 74/44

(57) ABSTRACT

The general field of invention is electrical connectors and their actuating mechanism. This invention teaches a novel mechanism for mating two parts of a register-free electrical connector. Although this invention can benefit many connector designs and applications, it is particularly beneficial when applied to hands free connectors for charging electric vehicles—also known in the industry as the Electric Vehicle Charge Couplers. The mechanism taught in this patent provides ability to bring two objects such as two sides of a connector together with following benefits: ability to stop the motion after reaching the target location, slide the two objects with respect to each other after mating, maintain a steady contact force, align the two sides of the contactor with respect to each other.

### CROSS REFERENCE TO RELATED APPLICATION

This application the claims the same priority as the previously filed provisional patent application No. 61/449,728, titles “Actuating Mechanism for Electric Charging System”, which is incorporated herein in its entirety by reference.

### FIELD OF THE INVENTION

The general field of invention is electrical connectors and their actuating mechanism. In general an electrical connector has a series of electrical conductors disposed on two parts that are separable. The two pieces can mate in such a manner that the associated conductors also meet with each other in a beneficial manner. The properties of mating of the two parts of any electrical connector are dictated by the mechanical arrangement—also known as the connector mechanism. This invention teaches a novel mechanism for mating two parts of a register-free electrical connector—first introduced in the U.S. patent application 12/168,137. Although this invention can benefit many connector designs and applications, it is particularly beneficial when applied to hands free connectors for charging electric vehicles—also known in the industry as the Electric Vehicle Charge Couplers.

### PRIOR ART RELATED TO THE INVENTION

A previous U.S. patent application: 12/168,137, identifies a class of electric connectors—register-free charge couplers, that do not require registration of the two sides of the connector, yet guarantee connectivity of multiple conductive channels over a wide range of relative positions and orientations of the two sides of the connector, thus permitting—for example, an electric vehicle to park at an arbitrary relative position with respect to the parking spot and yet be able to establish charging connections to the car. This is in sharp contrast with the traditional electric connectors whose two sides are mechanically guided to follow a precise relative position and orientation while mating. This particular distinction makes particularly difficult and un-obvious to implement some of the well-known mechanisms commonly found in traditional electrical connectors. This patent teaches how to make the register-free charge couplers to have self-cleaning ability, to be able to orient the conductors properly under indeterminate mating conditions as well as maintain a reliable and predefined contact force while permitting the two sides on the connector to move with respect to each other.

Mechanisms associated with connectors provide several functions such as interlock (U.S. Pat. No. 5,680,926), locking mechanism (U.S. Pat. No. 6,303,349 and U.S. Pat. No. 4,516,821), removing mechanism (U.S. Pat. No. 5,171,291), terminal retention mechanism (US2004/0121651), self-cleaning mechanism (U.S. Pat. No. 4,072,834).

Due to the specific nature of the connector this invention targets, the only mechanism relevant is self-cleaning mechanism, which is essentially a mechanism to slide the conductors relative to each other while retaining a desired, pre-determined contact force. In that sense the mechanism described in U.S. Pat. No. 4,072,834 represents the prior art that forces the sliding between contacts whose relative orientation and position is well defined. Also this well definition allows a predefined spring force to be designed into the mechanism. However in the case of register free connectors, the mating location is indeterminate. The actuating mechanism that brings the two sides of the connector together has to travel an unknown distance before the contacts could meet each other. Additionally the mechanism has to align the connectors on both sided to be parallel to each other. This is in sharp contrast to the prior art and hence the mechanisms described in prior art are not obviously transferable to the register-free connectors that this invention addresses.

### DETAILED DESCRIPTION OF THE INVENTION

A previous U.S. patent application: 12/168,137, identifies a class of conductive charge couplers that do not require registration of the two sides of the charge coupler, yet guarantee connectivity of multiple conductive channels over a wide range of relative positions and orientations of the two sides of the charge coupler, thus permitting an electric vehicle to park at an arbitrary relative position to the parking spot, and yet be able to establish charging connections to the car. Although most methods and actuating mechanisms of bringing together the two sides of the charge coupler are acceptable, there are particular desirable features of an actuating mechanism that can provide improved operations of the charge coupler.

In the following description, different objects and features are identified first with numbers, followed by small case letter as needed to identify a specific rendition of the said feature or object. Different dimensions that are critical for the functionality are identified by upper case letters and in some cases followed by a numbers to group together similar dimensions.

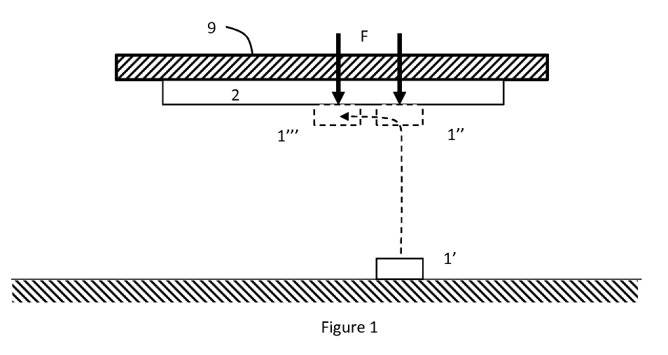

FIG. 1 shows the requirements for bringing two sides 1 and 2 of a register-free connector together. The initial positions of the two sides of the connector are 1′ and 2. From this position, the side 1′ needs to travel an indeterminate length in vertical direction to meet the side 2 in position 1″. Subsequently the side 1 needs to travel from its current position 1″ to 1″′. This last motion has to happen while maintaining a predefined contact force F between the two sides 1 and 2.

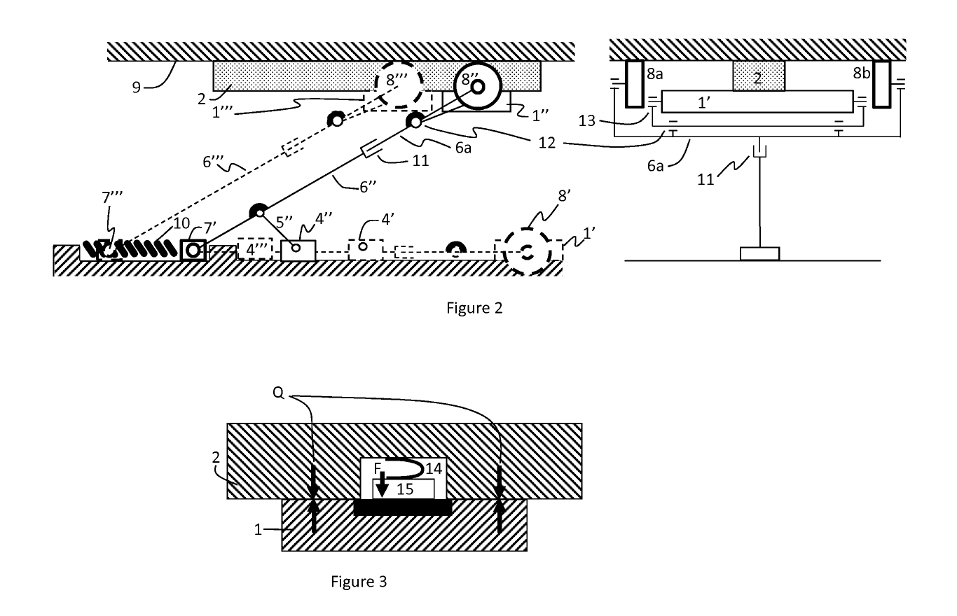

FIG. 2 shows the basic mechanism to achieve the desired motion as described in FIG. 1. The two sides of the connector are 1, 2, with the side 2 being mounted on a base 9. A lead screw actuated by a motor (not shown) actuates the slider 4. Alternatively the slider 4 can also be actuated by a pneumatic cylinder or a similar suitable actuation mechanism to achieve the same effect. The slider is part of a slider crank mechanism defined by the connecting rod 5, crank 6 and the crank center 7. With the actuation of slider 4 from its original position 4′ to 4″, the slider crank moves from its original position of 7′, 5′, 6′ to 7′, 5″, 6″. This brings the wheels 8, attached at the end of crank from its original position of 8′ to 8″. The wheel in position 8″ is resting against the rigid base 9 and cannot move further in vertical direction. A subsequent motion of slider from 4″ to 4′″ causes the entire crank to translate in horizontal direction from 6″ to 6′″, while the crank center pushes against its retaining spring 10. This brings the wheel 8 to its final position 8′″. By this time the wheel 8 has travelled essentially the same path as described in FIG. 1. When the wheels 8a and 8b first touch the base 9, they use the degree of freedom available in the swivel joint 11 to align the frame 6a parallel to the base 9. The connector 1 is mounted on frame 6a with two swivel joints 12 and 13, both with axis parallel to frame 6a. This in turn aligns the connector 1 to be parallel to base 9. The swivel joint 12 is spring loaded so that connector 1 in its position 1″ is pushed up against connector 2, while holding it parallel to the base 9.

FIG. 3 shows a zoomed in view of mated connectors 1 and 2. Each of the conductors 15 of side 2 is spring loaded by a leaf spring 14 which also acts as a current carrier. This spring force F is the final spring force acting across the conductor interface, while the spring force of swivel joint 12 is completely taken up by the interaction force Q between substrates of sides 1 and 2. Due to a predefined displacement of conductors 15, the conductor interaction force F is also pre-calibrated. However the force Q may depend on the amount of crank angle needed to reach the positions 7′, 5″, 6″, and could vary in real time.

An intricate interplay between three springs 10, 12 & 14; and the slider—crank that degenerates into slider—slider mechanism achieves the following desired features.
Ability to stop the motion after reaching the target location.
Slide the contacts with respect to each other after mating.
Maintain a steady contact force.
Align the two sides of the contactor with respect to each other.

In addition, while the mechanism is in its engaged state (7″′, 6″′, 5″′), if the base 9 moves closer to (or away from) ground 4, the crank pivots around crank pin. The side 1 conductors continue to hold against 2 even when base 9 moves closer or farther from ground—a situation representative of driver getting on or off the vehicle with base 9 being the vehicle frame.

1. A mechanism to move a first object in relation to a second object that comprises of
a slider, connecting rod and a crank with the first object suitably attached to the crank,
a first spring holding the crank center against a first mechanical stop.

2. A mechanism to move a first object in relation to a second object that comprises of
a slider, connecting rod and a crank,
a first spring holding the crank center against a first mechanical stop,
a first swivel joint mounted on the crank with its swivel axis substantially aligned with the crank,
a first frame carried by the first swivel joint and free to rotate with respect to the crank,
a first wheel and a second wheel with coincident axis and rotatable mounted on the first frame,
a second swivel joint mounted on the first frame with its axis parallel to the axis of the first wheel and the second wheel,
a second frame carried by the second swivel joint and biased upward by a second spring,
a third swivel joint mounted on the second frame with its axis parallel to the second swivel joint,
the first object carried by the third swivel joint.

3. A system comprising of
a mechanism defined in claim 2,
a second object,
at least one conductor carried by the second object and biased downward by a third spring.

4. The mechanism defined in claim 2 with the slider moved by a lead-screw and a motor.

5. The mechanism defined in claim 2 with the slider moved by pneumatic actuator.
